(19) United States
(12) Patent Application Publication
(10) Pub. No.: US 2010/0257017 A1
(43) Pub. Date: Oct. 7, 2010

(54) Product Sampling System And Method

(76) Inventors: Chris Mixson, Greenwich, CT (US); Amy Davenport, Bethel, CT (US); Richard Landy, New Rochelle, NY (US)

Correspondence Address: ST. ONGE STEWARD JOHNSTON & REENS, LLC, 986 BEDFORD STREET, STAMFORD, CT, 06905-5619, US

(21) Appl. No.: 12/416,799

(22) Filed: Apr. 1, 2009

(51) Int. Cl. G06Q 30/00; G06Q 10/00; G06F 15/16; A47F 3/00

(52) U.S. Cl. 705/10; 705/23; 709/204; 705/30; 312/234; 705/14.13; 705/14.36; 705/14.38

(57) ABSTRACT

A product sampling system including a sample code associated with a product sample, and a plurality of sample units provided to a retail location at no cost to the retail location, each sample unit including an indicia indicative of the sample code. The system further includes a database including identification data associated with loyalty members, software for reading the indicia from the sample units at the retail location and debiting a sample price associated with the sample units, and software for indentifying one or more consumers presenting the sample units at the retail location as being loyalty members based on the identification data. The system further includes software for crediting a price reduction equal to the sample price to each consumer identified as being a loyalty member, and for crediting the sample price to the retail location for each of the consumers not identified as being a loyalty member.

### FIELD OF THE INVENTION

This invention relates generally to a system and method for product sampling. More specifically the invention relates to a system and method for dispensing product samples and obtaining information for targeted advertising.

### BACKGROUND OF THE INVENTION

The distribution of product samples is known in the field of product marketing. For example, product samples are often distributed at point of sale locations to generate interest in new and existing products.

One common means of distributing product samples is demo or live sampling, where one or more representatives deliver product samples directly to customers at retail locations. Live sampling can facilitate the distribution of a relatively large number of samples to consumers. However, it has the disadvantage being expensive due to labor costs. Furthermore, there is no way to gauge the efficacy of a live sampling event or measure whether samples reach a target audience.

Product samples may also be distributed using various display devices. For example, U.S. Pat. No. 7,156,353 to Kringel et al. discloses an apparatus for displaying dispenser containers at point of sale locations. The apparatus allows for containers to be mounted to a store shelf so that customers can sample the contents of the container. U.S. Pat. No. 7,000,802 to Kringel et al. discloses a dispensing box for individual product samples, such as individual sample packets, for in-store advertising and promotion. Distributing samples using display devices is more cost effective than live sampling. However, like live sampling, it is difficult to determine the effectiveness of the sampling event when distributing samples from display devices.

There is a need in the art for a cost effective product sampling system and method that provides product manufactures and advertisers with information to determine the effectiveness of the sampling program and to determine whether a target audience is being reached.

### SUMMARY OF THE INVENTION

Accordingly, it is an object of the present invention to provide a product sample system and method that provides samples free of charge to consumers who are members of a loyalty program or that otherwise provide identifying information upon receipt of the sample. It is a further object to provide such a system and method that uses the identifying information to determine the effectiveness of the sampling program and to deliver promotions and coupons to samplers.

It is a further object of the present invention to provide a product sample system and method that can be offered at little or no cost to retailers and further provides a financial incentive to participating retailers.

These and other objectives are achieved by providing a product sampling system, including a sample code associated with a product sample, and a plurality of sample units provided to a retail location at no cost to the retail location, each sample unit including an indicia indicative of the sample code. The system further includes at least one database including identification data associated with each of a plurality of loyalty members, software for reading the indicia from the sample units at the retail location and debiting a sample price associated with the sample units, and software for indentifying one or more of a plurality of consumers presenting the sample units at the retail location as being loyalty members based on the identification data. The system further includes software for crediting a price reduction equal to the sample price to each of the consumers identified as being a loyalty member, and for crediting the sample price to the retail location for each of the consumers not identified as being a loyalty member.

In some embodiments, the software for identifying consumers reads a second indicia presented by at least a portion of the consumers, the second indicia indicative of identification data. The system may also include a product code associated with a product size package of goods included in the plurality of sample units, wherein the product code is different from the sample code.

In some embodiments, the sample price per quantity of goods in each sample unit is greater than a price per quantity of goods in the product size package of goods. In other embodiments, the sample price is a nominal or zero value.

The system may further comprise a display case at the retail location including each of the plurality of sample units. The display case may, for example, be a free-standing display device.

In some embodiments, the indicia are pre-printed on the sample unit. In other embodiment, indicia are removeably adhered to packaging of the sample units. The indicia may be a barcode.

In some embodiments, the system includes a sample database including records indicative of each of the loyalty members having presented at least one of the sample unit. The system may further include a promotional document, e.g., including a coupon, provided to at least a portion of the loyalty members identified in the sample database. The system may further include software for determining an efficiency of the product sampling system based on a comparison of the loyalty members identified in the sample database, the loyalty members identified in a coupon database, and a quality of the plurality of sample units.

Other objects of the present invention are achieved by provision of a method of distributing product samples, including the steps of assigning a sample code to a product sample, delivering a plurality of sample units to a retail location, each sample unit including a barcode indicative of the sample code, wherein the plurality of sample units are provided at no cost to the retail location, reading the barcode of at least one of the sample units presented at the retail location by one or more consumers, debiting a sample price associated with the one of the sample units to each of the one or more consumers, crediting a price reduction equal to the sample price to each of the consumers identified as a loyalty member, and crediting the sample price to the retail location for each of the consumers not identified as a loyalty member.

In some embodiments, the method further includes the step of determining an efficiency of the method of distributing product samples by evaluating the loyalty members having received a sample unit and a quality of the plurality of sample units.

In some embodiments, the method further includes the steps of determining each of the loyalty members having received a sample unit, and delivering a promotion item to at least a portion of the loyalty members having received a sample unit. In some such embodiments, the promotional document includes a coupon for the product size package of the goods included in the plurality of sample units, wherein the method further includes the step of determining each of the loyalty members having redeemed the coupon. The method may include a further step of determining an efficiency of the method of distributing product samples by comparing the loyalty members having received a sample unit, the loyalty members having redeemed the coupon, and a quality of the plurality of sample units.

Other objects of the invention and its particular features and advantages will become more apparent from consideration of the following drawings and accompanying detailed description.

### BRIEF DESCRIPTION OF THE DRAWINGS

FIG. 1A is a block diagram of a product sampling system according to an exemplary embodiment of the present invention.

FIG. 1B is another block diagram of the product sampling system shown in FIG. 1A.

FIGS. 2A-2C show a sample unit according to an exemplary embodiment of the present invention.

FIG. 3A shows a display case according to an exemplary embodiment of the present invention.

FIG. 3B shows another display case according to an exemplary embodiment of the present invention.

FIG. 4 illustrates a method for distributing product samples according to an exemplary embodiment of the present invention.

FIG. 5 illustrates a method for distributing product samples according to an exemplary embodiment of the present invention.

### DETAILED DESCRIPTION OF THE INVENTION

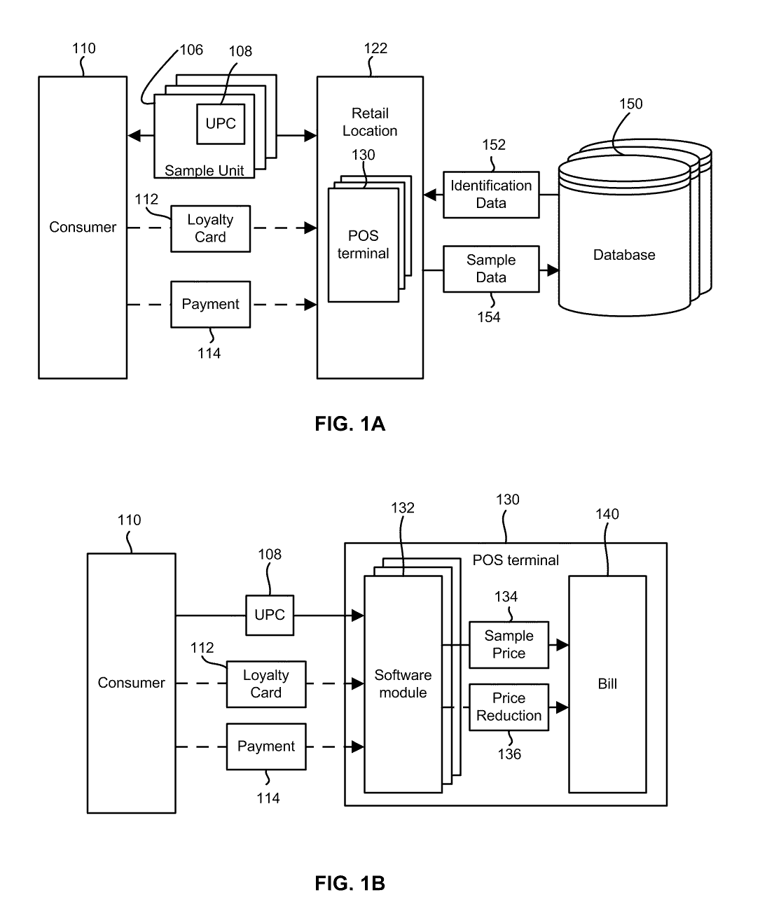

FIGS. 1A-1B illustrate a product sampling system according to an exemplary embodiment of the present invention. The system includes a plurality of sample units 106. The sample units 106 are delivered to one or more retail locations 122, e.g., by a manufacturer of the sample units 106 or by a marketer and/or advertiser administering a product sampling program. In preferred embodiments, the sample units 106 and the product sampling program associated therewith is provided to the retailer at no cost.

Each product sample unit 106 includes a sample code or universal product code (“UPC”) embodied in a barcode or other indicia 108 on the sample unit 106. For example, the indicia 108 may be a matrix barcode. The indicia 108 may be printed on the packaging of the sample unit 106. In some embodiments, the indicia 108 are adhered to the sample unit 106 prior to or at the retail location 122. For example, the indicia 108 may be provided on a sticker that may be affixed to the sample unit 106.

The product sample code is preferably unique to the product sample, and different from a code associated with a product size package of goods included in the sample unit 106. Sample units 106 may therefore be distinguished from product units of the same goods, and data pertaining to the receipt of each can be readily tabulated and compared. Furthermore, as described in more detail below, the retail product code and the sample code are preferably different because the sample units 106 are eligible for a price reduction 136 and the product units generally are not. In some embodiments, the sample code is a product code as opposed to a coupon code. For example, in some POS systems, coupon usages are tabulated and submitted to the relevant manufacturer for reimbursement, i.e., because the retailer has purchased the products from the manufacturer. However, in the present invention, the sample units 106 are preferably delivered to the retailer location 122 free of charge. Therefore, a coupon code and reimbursement from the manufacturer may not be applicable.

The retail location 122 includes a plurality of data entry or point of sale (“POS”) terminals 130 operating one or more software modules 132. The software modules 132 include, e.g., software for reading barcodes, tabulating the prices of products presented by consumers 110 for purchase, and processing payment. The software modules 132 further include software for reading the indicia 108 from a sample unit 106 and debiting (e.g., to a consumer's bill 140) a sample price 134 associated with the sample unit 106. The software described herein may be incorporated in the POS terminal 130, or may also be stored and/or executed on a server at the retail location 122 and/or remote thereto.

The system further includes one or more databases 150. The databases 150 include identification data 152 associated with a plurality of loyalty members. For example, the retail location 122 or a group of retail locations 122 may offer a loyalty program including, e.g., discounts and/or incentives to consumers 110 who provide identification data 152 for tracking the purchasing of the consumer 110 and/or for contacting the consumer 110 regarding promotions. Consumers 110 may identify themselves as loyalty members as the retail location 122 by presenting a loyalty card 112 (e.g., including a barcode or indicia) and/or by otherwise providing at least some identification information 152.

As illustrated in FIG. 1B, the POS terminal 130 and/or software module 132 reads the indicia 108 when a sample unit 106 is presented by a consumer 110. The software module 132 determines a sample price 134 associated with the sample unit 106 and debits the sample price 134 to the consumer's bill 140 (e.g., register receipt). The software 132 may then identify the consumer 110 as a loyalty member based on identification data 152. For example, the consumer 110 may present a loyalty card 112. The system reads the loyalty card 112 and queries the database 150 to verify the consumer 110 as a loyalty member. For loyalty members, the software module 132 applies a price reduction 136 to the consumer's bill 140. In preferred embodiments, the price reduction 134 is equal to the sample price 134. The system also stores sample data 154 in the database 150 indicating that the particular consumer 110 received a sample unit 106.

Consumers 110 who are not loyalty members and/or whose identification data 152 could not be obtained, provide a payment 114 in the amount of the sample price 134 (e.g., plus other purchase amounts and/or applicable taxes, etc.). In preferred embodiments, the retail location 122 and/or retailer receives and retains the sample price 134 paid by consumers who are not loyalty members. As discussed above, the retail location 122 generally receives the sample units 106 free of charge. Thus, retention of the sample price 134 provides an added financial incentive for retailers to participate in the sample program.

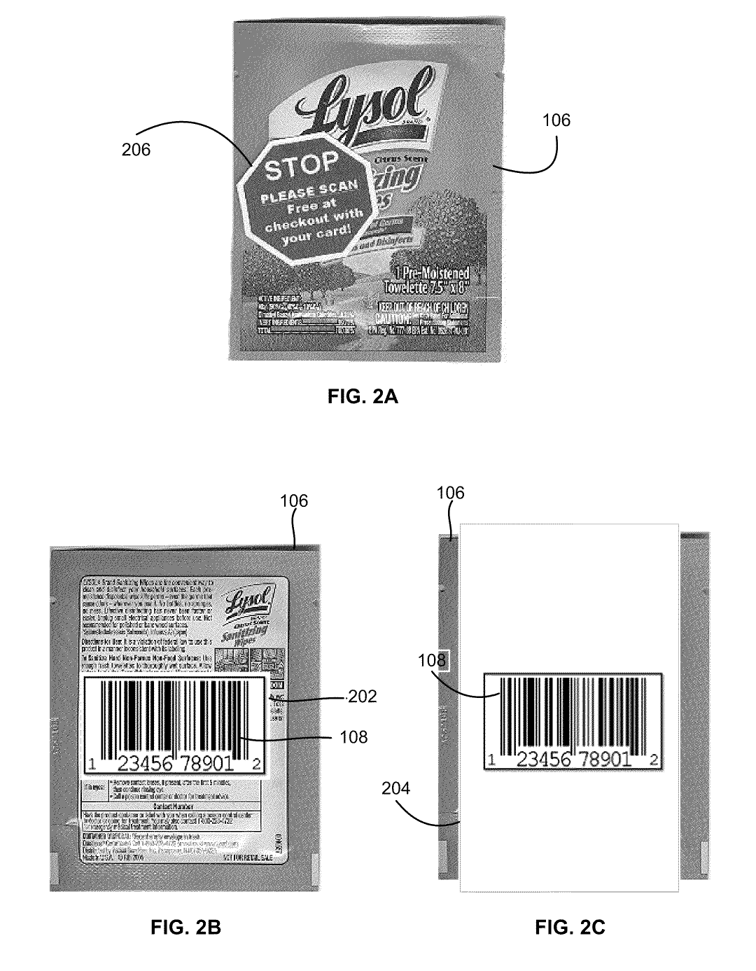

FIGS. 2A-2C illustrate an exemplary sample unit 106. The exemplary sample unit 106 includes an individual packaging including the indicia 108. In some embodiments, the indicia 108 is printed on the packaging of the sample unit 106. As shown in FIG. 2B, the indicia 108 may also be provided on a sticker 202 and adhered to the sample unit 106 prior to or at the retail location 122 (e.g., by an advertiser or the manufacturer). As shown in FIG. 2C, the indicia 108 may also be provided on a card 204 provided with and/or connected to the sample unit 106. In some embodiments, the sample unit 106 also includes a label 206 that functions to remind customers 110 and loyalty members to scan the product sample unit 106 and to use their loyalty card 112.

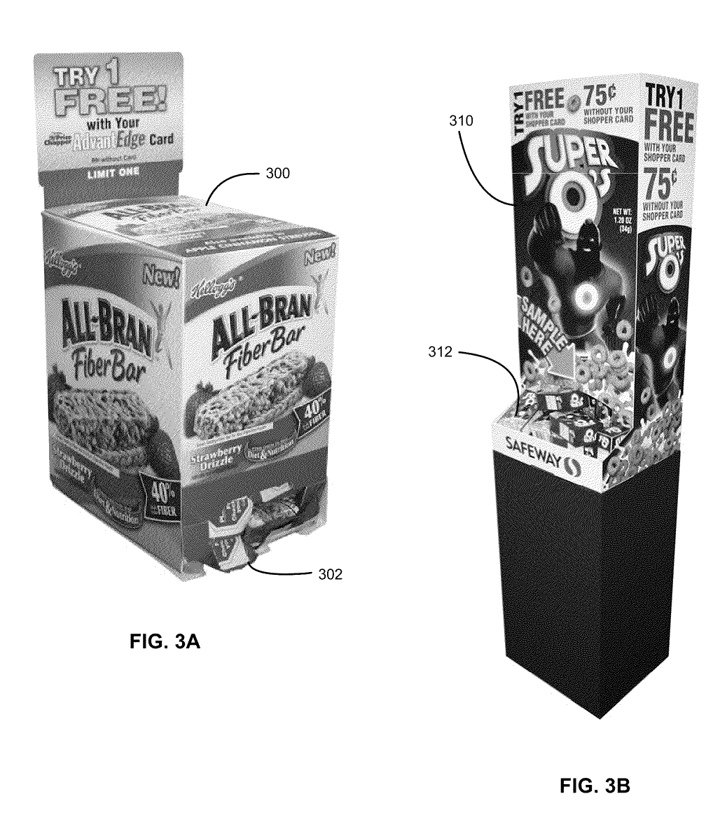

FIGS. 3A-3B illustrate display devices for dispensing sample units 106 employable by the present invention. A display case 300 is shown in FIG. 3A. The display case 300 may be placed or mounted on shelf at the retail location 122 (e.g., nearby associated product units) or, e.g., in the vicinity of the POS terminal 130. The display case 300 may contain relatively small product sample units 302 with a relatively low volume.

A second display case 310 is shown in FIG. 3B. The display case 310 is a free-standing display case for use on the floor at retail location 122. The display case 310 may contain a higher volume of sample units 312 and, if desired, larger sized sample units 312. The free-standing display case 310 provides an advantage of being able to store a relatively large number of sample units 312, thus increasing the amount of time that the display case 310 can provide sample units 312 to consumers 110 without being restocked. The free-standing display case 310 has a further advantage of being highly visible and attractive to consumers 110.

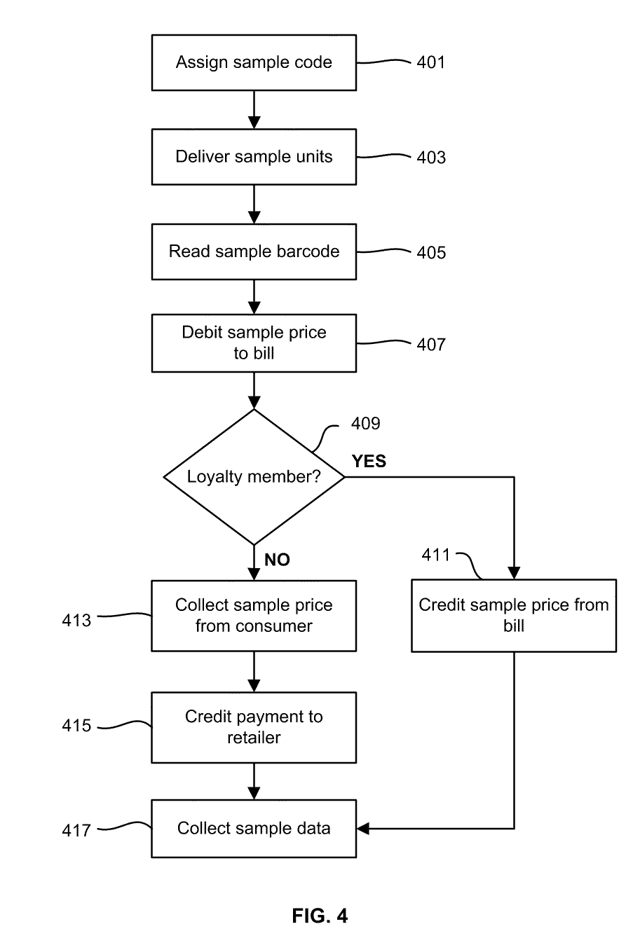

FIG. 4 illustrates a method of distributing product samples according to an exemplary embodiment of the present invention. The method includes a step of assigning a sample code to a product sample (401). As discussed above, the sample code is preferably different than a product code associated with a product size package of goods included in said plurality of sample units. It should be noted that it is preferable to have a product version of the sample unit 106 available at the retail location 122 during, or soon after, the sampling program is executed. Therefore, consumers 110 may be encouraged by the sampling program to purchase the product version. Moreover, the effectiveness of the sampling program and be gauged based on tracking the number of consumers 110 who return to purchase the product version.

In some embodiments, the sample price per quantity of goods in each sample unit 106 is greater than a price per quantity of goods in the product size package of goods, i.e., to discourage multiple purchases of samples instead of the product version. Such pricing also encourages the consumers 110 to scan a loyalty card 112 to obtain the sample unit 106 for free, rather than purchasing the sample unit 106. However, in some embodiments, the sample price is a small or nominal value. For example, the sample price may be less than five cents (U.S.) or less than one cent. A nominal value may be desirable to address any accounting issues that may arise in some systems associated with the retailer's receipt of a payment, or issuance of a credit, for a sample unit 106 that was received by the retail location 122 at no charge. For example, the use of a nominal value may be advantageous in some embodiments to avoid a false indication of a loss or gain resulting from the execution of the sampling method. In some other embodiments, the sample price is zero.

Referring again to FIG. 4, the sample units 106 are delivered to a retail location 122, each sample unit including a barcode indicative of the sample code (step 403). In preferred embodiments, the sample units 106 are provided at no cost to the retail location 122. The sample units 106 may be provided directly by a manufacturer, or by an advertiser and/or marketer administering the sampling program. For example, in one embodiment, the sample units 106 are produced by a manufacturer, and delivered to an advertising and/or marketing organization. The organization retrofits the sample units 106 with the indicia 108 and delivers the sample units 106 to one or more retail locations 110. The manufacturer compensates the organization directly for implementation of the product sampling program.

The barcode 108 on at least one of the sample units 106 presented at the retail location 122 by a consumer 110 may then be read (step 405). Upon reading the barcode 108, a sample price associated with the one of the sample units 106 is debited to the bill 140 of the consumer 110. If the consumer 110 is a loyalty member, a price reduction 136 equal to the sample price is credited from the consumer's bill 140 (steps 409-411). For example, the consumer 110 may present his/her loyalty card 112 at the POS terminal 130. Upon scanning the loyalty card 112, the software module 132 credits the price reduction 136.

Consumers 110 who are not identified as loyalty members are required to pay the sample price (step 413). The sample price is then credited to and retained by the retail location 122 (step 415). In some other embodiments, the retail location 122 does not permit consumers 110 who are not loyalty members to receive sample units 106 at all and thus the sample price is not collected or credited to the retailer. Sample data 154, e.g., indicative of the consumers who received the sample units 106, is then collected and stored (step 417).

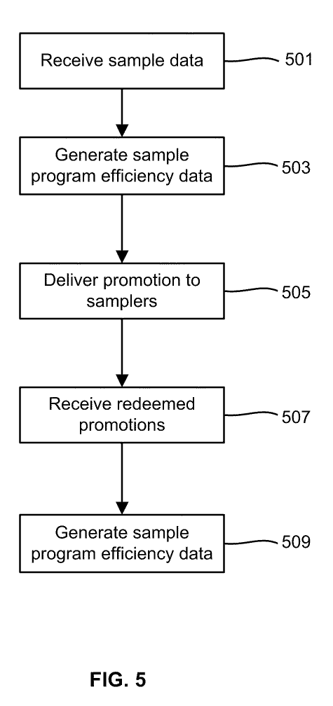

FIG. 5 further illustrates the method of distributing product samples according the present invention. After or during the distribution of samples at the retail location 122, sample data 154 is collected (step 501). For example, as each consumer 110 presents a sample unit 106 and a loyalty card 112, sample data 154 identifying each consumer 110 is collected and stored. The sample data 154 may be stored in the database 150 and/or a sample database or data records thereof. A marketer and/or advertiser administering the product sampling program may then receive the sample data 154 from the retail location 122. At this stage, sample efficiency data may be generated including, e.g., the number of sample units 106 distributed, identification data 152 associated the consumers 110, data concerning the group of consumers 110 having received the samples (e.g., demographic information, etc.) to determine what audiences where reached and/or whether a target audience was reached by the sampling program (step 503). The sample efficiency data may be embodied in a report and provided to the product manufacture and/or other sponsor of the sampling program.

Promotional materials may then be delivered to consumers 110 who received sample units 106 (step 505). For example, a coupon redeemable for a discount of the retail version of the product may be direct mailed or emailed to each of such consumers 110. The promotional materials may also include additional samples. The retail location 122, and/or other retail locations, may then receive and apply the coupons as they are presented by the consumers 110 (step 507). Preferably, only consumers 110 who had previously received a sample unit 106 for the particular product receive the promotion and/or coupon. Thus, upon redemption, a measure of repeat purchasers may be readily determined and stored. Data indicative of the consumers 110 who redeemed the promotion and/or coupon is stored in the database 150 and/or a coupon database or data records thereof. Data may also be determined and collected from the retail location 122 concerning consumers 110 who received a sample unit 106 (and/or a subsequent promotion) and then purchased the product version without using the coupon (e.g., provided the consumer 110 was identified at the time of the purchase). Subsequent purchases of identified consumers 110 may also be tracked and analyzed.

Additional sample program efficiency data is then generated (step 509). The data may be embodied in a report and provided to the product manufacture and/or other sponsor of the sampling program. In addition to the types of data previously generated, data indicative of the number of consumers 110 who received a sample unit 106 and then purchased the related product can also be determined. This provides a means to evaluate the effectiveness of the program not available with prior art sampling systems. This and other efficiency data that can be determined at this stage assist in evaluating and, if necessary, modifying the sampling program. Cost/benefit analyses may further be provided to evaluate the benefits of the sampling program to the manufacturer over time.

While the above are complete descriptions of preferred and other embodiments of the invention, other arrangements and equivalents are possible and may be employed without departing from the true spirit and scope of the invention. The terms and expressions which have been employed here are used as terms of description and not of limitations, and there is no intention, in the use of such terms and expressions, of excluding equivalents of the features shown and described, or portions thereof, it being recognized that various modifications are possible within the scope of the appended claims and their full scope of equivalents.

What is claimed is:

1. A product sampling system, comprising:
a sample code associated with a product sample;
a plurality of sample units provided to a retail location at no cost to the retail location, each sample unit including an indicia indicative of said sample code;
at least one database including identification data associated with each of a plurality of loyalty members;
software for reading the indicia from said sample units at the retail location and debiting a sample price associated with said sample units;
software for indentifying one or more of a plurality of consumers presenting said sample units at the retail location as being loyalty members based on the identification data;
software for crediting a price reduction equal to the sample price to each of the consumers identified as being a loyalty member, and for crediting the sample price to the retail location for each of the consumers not identified as being a loyalty member.

2. The system according to claim 1, wherein said software for identifying consumers reads a second indicia presented by at least a portion of the consumers, the second indicia indicative of at least a portion of the identification data.

3. The system according to claim 2, wherein the second indicia is one of a barcode and a magnetic strip.

4. The system according to claim 1, further comprising:
a product code associated with a product size package of goods included in said plurality of sample units, wherein the product code is different from the sample code.

5. The system according to claim 4, wherein the sample price per quantity of goods in each sample unit is greater than a price per quantity of goods in the product size package of goods.

6. The system according to claim 1, further comprising:
software for limiting a number of sample units for which a price reduction is applied, said software preventing the credit of the price reduction for each second one of said sample units presented by each loyalty member.

7. The system according to claim 1, further comprising:
a display case at the retail location comprising each of said plurality of sample units.

8. The system according to claim 7, wherein the display case is a free-standing display case.

9. The system according to claim 1, wherein each of said sample units including an individual packaging including the indicia.

10. The system according to claim 9, wherein the indicia is removeably adhered to the individual packaging.

11. The system according to claim 1, wherein the indicia is a barcode.

12. The system according to claim 1, further comprising:
a sample database comprising records indicative of each of the loyalty members having presented at least one of said sample unit at the retail location.

13. The system according to claim 12, further comprising:
software for determining the effectiveness of the product sampling system based on a the loyalty members identified in the sample database and a quality of said plurality of sample units.

14. The system according to claim 12, further comprising:
a promotional document provided to at least a portion of the loyalty members identified in said sample database.

15. The system according to claim 14, wherein said promotion document is provided by electronic mail.

16. The system according to claim 14, wherein the promotional document includes a coupon for the product size package of the goods included in said plurality of sample units.

17. The system according to claim 16, further comprising:
a coupon database comprising records indicative of each of the loyalty members having redeemed the coupon.

18. The system according to claim 17, further comprising:
software for determining the effectiveness of the product sampling system based on a comparison of the loyalty members identified in the sample database, the loyalty members identified in the coupon database, and a quality of said plurality of sample units.

19. A method of distributing product samples, comprising the steps of:
assigning a sample code to a product sample;
delivering a plurality of sample units to a retail location, each sample unit including a barcode indicative of said sample code, wherein the plurality of sample units are provided at no cost to the retail location;
reading the barcode of at least one of the sample units presented at the retail location by one or more consumers;
debiting a sample price associated with the one of said sample units to each of the one or more consumers;
crediting a price reduction equal to the sample price to each of the consumers identified as a loyalty member; and
crediting the sample price to the retail location for each of the consumers not identified as a loyalty member.

20. The method according to claim 19, further including the step of
determining an efficiency of the method of distributing product samples by evaluating the loyalty members having received a sample unit and a quality of the plurality of sample units.

21. The method according to claim 19, further comprising the steps of:
determining each of the loyalty members having received a sample unit; and
delivering a promotion item to at least a portion of the loyalty members having received a sample unit.

22. The method according to claim 21, wherein the promotional document is delivered by electronic mail.

23. The method according to claim 21, wherein the promotional document includes a coupon for the product size package of the goods included in said plurality of sample units, wherein the method further comprises the step of determining each of the loyalty members having redeemed the coupon.

24. The method according to claim 23, further comprising the step of:
determining an efficiency of the method of distributing product samples by comparing the loyalty members having received a sample unit, the loyalty members having redeemed the coupon, and a quality of said plurality of sample units.

25. The method according to claim 19, wherein one or more consumers are identified as loyalty members by reading a second indicia presented by each of the one or more the consumers and querying a database including identification data associated with a plurality of loyalty members.

26. The method according to claim 19, further comprising the steps of:
providing a product code associated with a product size package of goods included in said plurality of sample units, wherein the product code is different from the sample code.

27. The method according to claim 26, wherein the sample price per quantity of goods in each sample unit is greater than a price per quantity of goods in the product size package of goods.

28. The method according to claim 19, further comprising the step of:
limiting a number of sample units for which a price reduction is applied by preventing the credit of the price reduction for each second one of said sample units presented by each loyalty member.

29. The method according to claim 19, wherein each of said sample units including an individual packaging including the indicia, wherein the indicia is removeably adhered to the individual packaging.

30. The method according to claim 19, wherein the sample price is a nominal value.

31. The method according to claim 19, wherein the sample price is less than or equal to five cents.

32. The method according to claim 19, wherein the sample price is less than or equal to one cent.
